(19) United States
(12) Patent Application Publication
(10) Pub. No.: US 2013/0224641 A1
(43) Pub. Date: Aug. 29, 2013

(54) NONMAGNETIC SINGLE-COMPONENT DEVELOPER, DEVELOPMENT MACHINE CARTRIDGE, PROCESS CARTRIDGE AND IMAGE FORMING APPARATUS

(71) Applicants: Kabushiki Kaisha Toshiba, (US); Toshiba Tec Kabushiki Kaisha, (US)

(72) Inventor: Hiroshi Kawaguchi, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/756,732

(22) Filed: Feb. 1, 2013

Related U.S. Application Data
(60) Provisional application No. 61/602,689, filed on Feb. 24, 2012.

(30) Foreign Application Priority Data
Dec. 13, 2012 (JP) 2012-272764

(51) Int. Cl. G03G 9/00; G03G 15/08

(52) U.S. Cl. CPC G03G 9/08; G03G 21/18; G03G 15/0865; G03G 15/08
USPC 430/105; 399/252; 430/108.7

(57) ABSTRACT

A nonmagnetic single-component developer uses an external additive which contains α percent by weight of wet silica having an average particle size of 80-150 nm and β percent by weight of burning silica having an average particle size of 8-20 nm. β/α is 2-5, and α+β is 2-10 percent by weight. After a silica separation test is conducted, the residual ratio X is 50-95 percent by weight, the percentage of the ratio of the residual amount of the silica a/b is in the rage of (X²/(1+β/α)/100)/(X−X²/(1+β/α)/100)×100 to (X²/(1+β/α)/100×((1−X/100)+1))/(X−X²/(1+β/α)/100×((1−X/100)+1))×100.

### CROSS-REFERENCE TO RELATED APPLICATION

This application is based upon and claims the benefit of priority from: U.S. provisional application 61/602,689 filed on Feb. 24, 2012; and JP application No. 2012-272764 filed on Dec. 13, 2012; the entire contents of each of which are incorporated herein by reference.

### FIELD

Embodiments described herein relate to a nonmagnetic single-component developer and a development machine cartridge, a process cartridge and an image forming apparatus using the nonmagnetic single-component developer.

### BACKGROUND

Conventionally, the deterioration caused by the mechanical stress resulting from the use of a developer contributes to the generation of an image of poor quality, as a solution, an appropriate change is made to the type and the amount of the external additive used as well as the control on the charge properties of toner particles.

The deterioration of the nonmagnetic single-component toner in a developing apparatus, which is provided with a photoconductor and a developing roller that are contacted with each other, is mainly due to the separation of an external additive from the surface of the toner under the stress of a developing roller and photoconductor nip unit generated accompanied by the electrification caused by the agitation or friction in the developing apparatus, as charge properties is significantly changed after the separation, an image is changed.

### BRIEF DESCRIPTION OF THE DRAWINGS

FIG. 1 is a schematic diagram showing an example of an image forming apparatus applicable in an embodiment.

FIG. 2 is a diagram illustrating the relationship between the total addition amount of the added wet silica and burning silica and the percentage of the ratio of the residual amount (a) of the wet silica to the residual amount (b) of the burning silica.

### DETAILED DESCRIPTION

In accordance with an embodiment, a nonmagnetic single-component developer comprises: toner particles containing a binder resin and a coloring material; and

an external additive which is adhered on the surfaces of the toner particles and contains wet silica having a volume average primary particle size of 80-150 nm and accounting for α percent by weight of the total weight of the developer and burning silica having a volume average primary particle size of 8-20 nm and accounting for β percent by weight of the total weight of the developer, wherein

the ratio of β to α (β/α) is 2-5,

the total addition amount of the added wet silica and burning silica (α+β) is 2-10 percent by weight,

the residual ratio X of the wet silica and the burning silica left after a separation test to the total addition amount (α+β) of the wet silica and the burning silica calculated before the separation test is 50-95 percent by weight when the separation test of the wet silica and the burning silica is carried out by a centrifugal separation apparatus, and

the lower limit value and the upper limit value of the percentage of the ratio (a/b) of the residual amount (a) of the wet silica to the residual amount (b) of the burning silica are represented by the following formulas (1) and (2)

a/b(lower limit value)percent=(X²/(1+β/α)/100)/(X−X²/(1+β/α)/100)×100 (1)

a/b(upper limit value)percent=(X²/(1+β/α)/100×((1−X/100)+1))/(X−X²/(1+β/α)/100×((1−X/100)+1))×100 (2).

The wet silica is prepared by neutralizing silicic acid natrium with mineral acid using a precipitation method.

The burning silica refers to dry silica prepared by burning silica tetrachloride in oxygen and hydrogen flame using a burning method.

The separation test is conducted on the wet silica and the burning silica for 15-60 min using the centrifugal separation apparatus at a speed of 800-1200 r/min.

In accordance with the embodiments herein, the difficulty of the separation of an external additive of the developer can be controlled according to the type of the external additive. In this way, each external additive can be remained at such a percentage that does not change the charge properties significantly after the separation.

As stated above, at least two kinds of the silica are needed to be used as the external additive used in the embodiments herein.

A first silica refers to silica prepared by a wet method and having an volume average primary particle size of 80-150 nm, and a second silica refers to silica prepared by a pyrolysis process and having an volume average primary particle size of 8-20 nm.

The second silica with extremely excellent charge properties applies charges to the toner easily. The big-sized first silica with poor charge properties also has a function of prohibiting small-sized silica such as the second silica from being charged and preventing over-charging based on a spacing effect. Therefore, a toner with desirable charge properties can be obtained by using the first and second silica in a given compounding ratio. In embodiments herein, if the external additive is separated and the total amount of the silica on the surface of the toner is reduced due to the use of the developer, the adhesion strength of each silica can be controlled so that the residual amount of the second silica is greater than that of the first silica. For example, in the case where the first silica and the second silica, the total amount of which accounts for 3% by weight of the weight of the toner, are added to the initial toner in a ratio of 1:2, and the total amount of the first and second silica is reduced to 2% by weight due to the deterioration caused by the use of the developer, as the total amount of the first and second silica is reduced, if the first and second silica are remained in a ratio of 1:2, the charge properties of the toner will be greatly lowered. However, it if is controlled that the first silica and the second silica are remained in a ratio of 1:3, as the percentage of the second silica with excellent charge properties is high and the spacing effect generated by the first silica is reduced, the charge properties is maintained even the total amount of the first and second silica is reduced to 2%. By controlling the separation difficulty of the first and second silica according to the condition of externally-added equipment in this way, a desirable toner can be obtained.

Polyester resin, styrene-acrylic resin and the like can be listed as the binder resin used for the nonmagnetic single-component developer described in embodiments herein.

In the case of the use of polyester resin, polyester resin can be prepared with a monomer includes an acid component consisting of carboxylic acid compounds having a valence of above 2 and an alcohol component includes polyhydric alcohol having a valence of above 2.

The following components are given as examples of acid components: fumaric acid, maleic acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, succinic acid or anhydride of those acid replaced by an alkyl group carbon number of 1-20 or an alkenyl group carbon number of 2-20 such that dodecenyl succinic acid, octyl succinic acid, a derivative of alkyl ester and the like.

The following components are given as examples of ethanol components: aliphatic polyols such as ethylene glycol, propylene glycol, 1,4-butanediol, 1,3-butanediol, 1,5-Pentanediol, 1,6-Hexane diol, neo pentane glycol, glycerin, trimethylolethane trimethylolpropane and pentaerythritol, cycloaliphatic polyols such as 1,4-cyclohexanediol and 1,4-cyclohexanedimethanol, ethylene oxides such as bisphenol A or additives of propylene oxide.

In the case of the use of styrene-acrylic resin, polymers of styrene, copolymers of styrene and diene and copolymers of styrene and alkyl(meta)acrylate can be listed.

Natural waxes such as carnauba wax carba and rice wax and synthetic waxes such as ester, paraffinic, polypropylene and polyethylene can be used as a mold release agent.

A yellow pigment represented by carbon black, P.Y180, P.Y74, P.Y17, P.Y185 and P.Y93 and generally used as a toner, a magenta pigment represented by P.R122, P.R185, P.R57:1, P.R31, P.R238, P.R269, P.R146, P.R147, P.R184 and P.V19 and generally used as a toner and a cyan pigment represented by P.B15 and P.G7 and generally used a toner can be listed as a coloring material used in embodiments herein.

Typically, a hydrophobic metal oxide compound such as a metal-containing azo compound, a metal-containing salicylic acid and derivates thereof is used as a charge control agent used in embodiments herein. In the hydrophobic metal oxide compound, the metal element is the complex or complex salt of zirconium, zinc, Chromium and Boron or the mixture thereof, or the charge control agent may contain no metal.

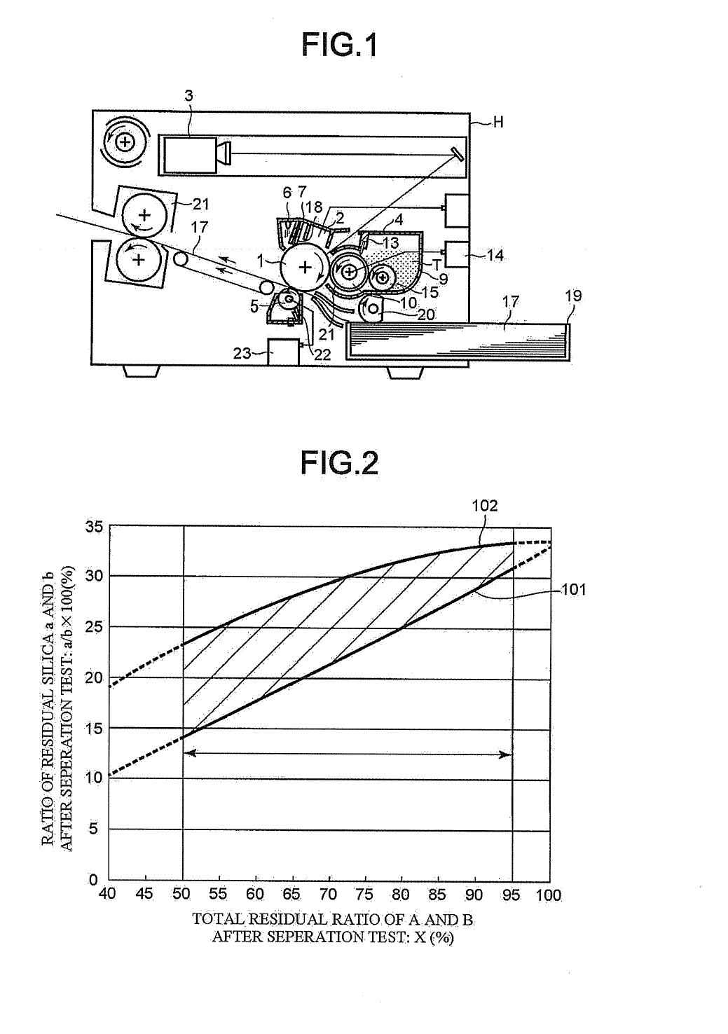

FIG. 1 is a diagram illustrating the configuration of an exemplary image forming apparatus capable of using the nonmagnetic single-component developer according to embodiments herein.

A photoconductive drum 1 serving as an image carrier having a recording surface (that is with a small diameter) smaller than the area of an image to be recorded is configured on the substantially central part of the main body H of the image forming apparatus along the arrowhead direction A in a freely rotatable manner. The photoconductive drum 1 is made from a photoconductive material of an organic photoconductor (OPC). Further, a charger 2, a laser apparatus 3, a developing apparatus 4 serving as a developer cleaning unit, a transfer roller 5 serving as a transfer component, a charge removing lamp 6 and a stirrer apparatus 7 serving as an image agitation unit are orderly configured around the photoconductive drum 1 along the rotation direction of the photoconductive drum.

The charger 2 is configured above the photoconductive drum 1 to charge the surface of the photoconductive drum 1 with electric power of −500 to −800V in a substantially uniform manner. The laser apparatus 3 irradiates laser beams 8 towards the surface of a photoconductor according to the image information to be recorded, thereby forming an electrostatic latent image on a charged area.

Further, a hopper 9 for holding the called single-component developer T which is frictionally charged is configured in the developing apparatus 4. An elastic developing roller (referred hereinafter to as developing roller) 10 is configured in the hopper 9 to convey the developer T to a position facing the photoconductive drum 1 and convey the developer T left on the photoconductive drum 1 back into the hopper 9.

A conductive surface layer 11 having a resistance of 102-1090 cm is configured on the developing roller 10 and an elastic layer 12 formed by urethane foam is configured in the developing roller 10 so that an elastic roller is formed on the whole developing roller 10.

The developer T on the developing roller 10 is frictionally charged while an elastic blade 13 includes Phosphor bronze, Urethane or silicon resin for forming a thin layer is pushed to the developing roller 10, and the developer T passing through the developing roller 10 is charged with a negative electric power having the same polarity with the photoconductive drum 11 to form one or two layers of developer. Additionally, when selecting a material for the surface of the developing roller 10 serving as a developer carrier, the frictional charging between the surface and the developer T and proper elasticity and frictional property should be taken into consideration.

The surface layer 11 is made from a material obtained by mixing conductive carbon, at a percentage of 10-30% by weight, in Urethane resin. Moreover, the developing roller 10 is connected with a bias supply 14 serving as a voltage applying unit to communicate with the surface layer 11. In this way, a given developing bias is applied during development and cleaning processes. A sponge-shaped developer conveying roller 15 is also configured in the hopper 9 to prevent the condensation of the developer T in the hopper 9 and to convey the developer T.

Further, the developing apparatus 4 can be box-shaped to produce a development machine cartridge, which can be detachably configured on the image forming apparatus.

Further, the photoconductive drum 1 can be integrated with the developing apparatus 4 to form a process cartridge, which can be detachably configured on the image forming apparatus.

The transfer roller 5 is substantially configured opposite to the circumferential surface of the photoconductive drum 1 with a paper conveyance path spaced between the transfer roller 5 and the photoconductive drum 1. The resistance of the surface layer 11 of the transfer, roller 5 structurally identical to the developing roller 10 is, for example, 105-10100 cm. With the transfer roller 5, a positive voltage is applied to the back side of the paper 17 conveyed thereto by the transfer roller 5 to suck the toner in an electrostatic manner and transfer a toner image from the photoconductive drum 1 onto the paper 17. In a transfer unit of such a contact type, as a stable transfer property can be exerted even there is a great amount of moisture, the amount of the developer left after the transfer process is reduced, which reduces cleaning workload and removes the paper powder from the transferred paper to prevent the paper powder from mixing with the developer. A conductive elastic brush 18 is configured in the stirrer apparatus 7, with its top end contacted with the photoconductive drum 1. The elastic brush 18 is slidingly contacted with the photoconductive drum 1 by means of the rotation of the photoconductive drum 1 and applied with a voltage of 0-400V so as to stir the developer left on the photoconductive drum 1 from the transfer to be in an unreadable state, that is, to be unpatterned the residual developer, and the residual electrostatic latent image is also de-staticalized using the conductive elastic brush 18 to be removed. Further, the charges on the negative side of the photoconductive drum 1 are removed by an erase lamp 6 in advance, thus, the destaticization of the elastic brush 18 refers mainly to the destaticization from the positive side of the photoconductive drum.

Further, the stirrer apparatus 7 is configured at an upper position with respect to the photoconductive drum 1, preventing the splash of the developer accumulated in the elastic brush 18 in the machine body, that is, even the developer falling on the photoconductive drum 1 can be directly conveyed to the developing apparatus 4 to be recycled.

Further, a paper feed unit 19 for feeding paper P to the conveyance path 16 is configured below the photoconductive drum 1. The paper P, onto which an image should be transferred, is housed in the paper feed unit 19. A paper feeding roller 20, which rotates to feed paper 17 from the paper feeding unit 19 to the conveyance unit path 16, is configured above the paper feed unit 19.

Further, a fixer 21 for fixing the transferred toner image on the paper 17 is configured in the conveyance path 16.

Next, actions of the image forming apparatus are described.

The photoconductive drum 1 is rotated along the arrowhead direction A, and the periphery of the photoconductive drum 1 is corona-charged with electric power of minus 500-minus 800V by the charger 2. Next, the laser apparatus 3 irradiates laser beams from the charged area to expose to form an electrostatic latent image on the surface of the photoconductive drum 1. The electrostatic latent image is then conveyed to a developer cleaning position opposite to the developing apparatus 4. The developer (referred hereinafter to as toner) T is conveyed out from the developing roller 10 of the developing apparatus 4, by action of this, toner T deposits onto the electrostatic latent image by elastically contact of nip width, thereby a toner image is formed. In this case, the toner T is adhered to a light irradiated area to conduct the called reversal development. The toner T is charged with an electric power of about minus 5-minus 30 μc/g through friction with the blade 23 and the surface layer 11 of the developing roller 11, and a voltage of about −250 to −450V is applied to the developing roller 10.

The developed toner image is then conveyed to a transfer area facing the transfer roller 5. On the other hand, the paper 17 is synchronously rotated with the photoconductive drum 1 through the rotation of the paper feeding roller 20 to be conveyed to the transfer area from the paper feed unit 19.

With the transfer roller 5, the back side of the paper 17 is charged with an electric power having a plus polarity. Thus, the toner image on the surface of the photoconductive drum 1 is electro-statically absorbed and transferred onto the paper P. In the transfer roller 5, a voltage of 1000V-2000V is applied to the rotation shaft of the transfer roller 5 by a direct power source 23, and the voltage is applied to the conductive surface portion of the roller surface having a resistance of 10⁵-10⁹ Ωcm via a conductive unit formed by mixing 30-40% by weight of conductive carbon to silicon resin configured at two ends of the transfer roller 5. Further, in order to clean the developer and paper powder adhered on the surface of the transfer roller 5, the surface of the transfer roller 5 is preferably made from a material having a smooth surface and poor frication property, such as conductive fluoride resin or conductive polyester, and the developer and paper powder adhered on the surface of the transfer roller is effectively cleaned by a cleaning blade 22. Moreover, if the transfer roller having the hardness of 25-50 degree measured according to JIS (Japanese Industrial Standards) method applied, the press force thereof has a great capacity to adapt to the photoconductive drum 1 of the transfer roller 5, can bring a good result.

The transferred paper 17 is conveyed to the fixer 21 in which the toner is melted and fixed on the paper 17 and then discharged.

### EMBODIMENTS

Embodiments and detailed description thereof are given below.

EMBODIMENTS 1-22 AND COMPARATIVE EXAMPLES 1-20

Preparation of Samples of External Additive

If silica having a first volume average primary particle size and accounting for α% by weight is set as the silica A and silica having a larger second volume average particle size and accounting for β% by weight is set as the silica B, as shown in following tables 1, 2, 4 and 5, for either of wet silica and burning silica by changing volume primary particle size φA of the silica A, volume primary particle size φB of the silica B, the residual ratio X, the total additive amount (α+β) and the compounding ratio (β/α), the external additive can be obtained in different compounding ratios.

In addition, in preparing the toner, in order to adjust the residual ratios of the used silica A and the used silica B on purpose, the temperature, the rotation number and the agitation time involved in the external addition are changed using a Henschel mixer to obtain various samples of the external additive.

Preparation of Sample of Developer

89.5 shares of polyester resin, 5 shares of rice bran wax, 5 shares of carbon black and 0.5 share of salicylic acid compound functioning as a charging control material are mixed using the Henschel mixer, the mixture is melt kneaded using a twin-screw extrusion type kneader, and then pulverized and classified to obtain toner particles having an average particle size of 6.5 μm.

Each sample of the external additive above is added on the surface of the obtained toner particle and stirred using the Henschel mixer, and then the mixture is screened with a 150-size mesh to obtain a developer sample.

Each obtained developer sample is subjected to the following test:

Silica Separation Test Realized Through Centrifugation

(Separation Process)

Add and mix 11 shares by weight of the toner, 56.8 shares by weight of ion exchanged water and 12.8 shares by weight of a surfactant in a 100 ml beaker, stir the mixture using a magnetic stirrer until there is no toner layer on the liquid level.

(Impact Process)

Input ultrasonic waves to the dispersion using an ultrasonic cleaner (ASONE US-1R) to output sound waves of 42 kHz for 10 min.

(Separation Process)

After the impact process, inject the dispersion into two centrifugal tubes, add ion exchanged water so that there is 45 ml liquid in each centrifugal tube.

Then, conduct centrifugation on the centrifugal tube for 15 min with a centrifugal separation apparatus (HSIANGTAI CN-2060) at a speed of 1000 rotations/min,

Then, remove the supernatant in the centrifugal tube through decantation and ion exchanged water is added so that there is 45 ml liquid in each centrifugal tube to stir the mixture again.

Then, conduct the centrifugation process and the agitation process following the addition of ion exchanged water twice.

(Cleaning Process)

Add 100 ml ion exchanged water into the toner from which the external additive is separated through the separation process to filter, wherein the filter paper used in the process is ADVANTEC GC90.

(Drying Process)

Conduct vacuum drying on the obtained toner for 8 h to obtain a toner subjected to the silica separation test.

Actual Measurement on Residual Ratio a/b of Silica

Identify and confirm the residual silica A/B left in the toner subjected to the silica separation test using a scanning electron microscope which amplifies an object by 20000 times in five fields, visually inspect the numbers of the residual silica A and B to obtain an average, then calculate the numbers b of the silica B and the numbers a of the silica A. Additionally, calculate the residual ratio a/b of the number a of the silica A to the number b of the silica B and the percentage of the residual ratio.

The obtained result is shown in the following Table 2 and Table 4.

The following measurements are conducted prior to and after the silica separation test.

A two-component image forming apparatus e-STUDIO2500C produced by Toshiba Corporation is used in the following evaluations.

Measurement of Image Density

Measure, using a Macbeth density meter 19I, image density for an image which is fixed when the amount of the toner transferred on a paper in the case of a 100% printing pattern is 0.5mg/cm²; give an evaluation result ‘◯’ if the measured result is above 1.3, give an evaluation result ‘□’ if the measured result is greater than or equal to 1.1 but smaller than 1.3, and give an evaluation result ‘×’ if the measured result is below 1.1.

Measurement on Fogging

Print 0% printing pattern on the condition that image density is measured and measure fogging using X-Rite; give an evaluation result ‘O’ if the measured result is below 2.0%, give an evaluation result ‘□’ if the measured result is greater than or equal to 2.0% but smaller than 3.0%, and give an evaluation result ‘×’ if the measured result is greater than or equal to 3.0%.

Measurement on Residual Amount of Cartridge

Print 30% printing pattern continuously after 100 g toner is filled into the cartridge until it is confirmed that the toner is empty, the residual amount in the cartridge is measured by the weight of the residual toner measured at the moment the empty is confirmed; give an evaluation result ‘◯’ if the measured result is below 30 g, give an evaluation result ‘□’ if the measured result is greater than or equal to 30 g but smaller than 40 g, and give an evaluation result ‘×’ if the measured result is greater than or equal to 40 g.

Measurement on Blocking of Toner

Place 50 g toner in a 55° C. thermostat for 10 h, then vibrate with a powder tester, screen the toner with a 200-size mesh to measure the blocking of the toner; give an evaluation result ‘◯’ if the obtained result is that the amount of the toner left on the mesh is smaller than 10 g, give an evaluation result ‘□’ if the obtained result is that the amount of the toner left on the mesh is greater than or equal to 10 g but smaller than 15 g, and give an evaluation result ‘×’ if the obtained result is that the amount of the toner left on the mesh is greater than or equal to 15 g.

Measurement on Fixability

Fixability is measured by conducting a tape strip test on the pattern the same as the measurement of image density. As a result of evaluation, if the obtained result is that the image density maintenance rate is greater than or equal to 80% after the strip, the result of evaluation is ‘◯’, if the obtained result is that the image density maintenance rate is greater than or equal to 70% but smaller than 80% after the strip, the result of evaluation is ‘□’, if the obtained result is that the image density maintenance rate is smaller than 70% after the strip, the result of evaluation is ‘×’.

The results of the measurements above are shown in the following Table 3 and Table 6

Measurement on Residual Ratio X

(Molded Process)

Measure 5.0 g of the toner obtained from the drying process and mold the toner into a pellet shape with a molded mill.

(Measurement Process)

Measure the pellet molded in the molded process with a fluorescent X-ray analyzer (Shimadzu Corporation XRF-1800).

When the X-ray intensity of the residual silica obtained in such a way is set to be S1 and that of the toner available prior to the processes above is set to be S0, then the residual ratio X (%) is calculated to be S1/S0*100.

The obtained result is shown in the following Table 2 and Table 5

TABLE 1

| | | | | | | ROTATION | |
|---|---|---|---|---|---|---|---|
| | | | φA | φB | TEMPERATURE | NUMBER | AGITATION |
| | A | B | (nm) | (nm) | (° C.) | (ROTATIONS/MIN) | TIME(MIN) |
| COMPARATIVE | BURNING | BURNING | 110 | 12 | 25 | 2000 | 5 |
| EXAMPLE 1 | | | | | | | |
| COMPARATIVE | BURNING | WET TYPE | 110 | 20 | 25 | 2000 | 5 |
| EXAMPLE 2 | | | | | | | |
| COMPARATIVE | WET TYPE | WET TYPE | 110 | 20 | 25 | 2000 | 5 |
| EXAMPLE 3 | | | | | | | |
| COMPARATIVE | WET TYPE | BURNING | 75 | 12 | 25 | 2000 | 5 |
| EXAMPLE 4 | | | | | | | |
| COMPARATIVE | WET TYPE | BURNING | 160 | 12 | 25 | 2000 | 5 |
| EXAMPLE 5 | | | | | | | |
| COMPARATIVE | WET TYPE | BURNING | 110 | 6 | 25 | 2000 | 5 |
| EXAMPLE 6 | | | | | | | |
| COMPARATIVE | WET TYPE | BURNING | 110 | 30 | 25 | 2000 | 5 |
| EXAMPLE 7 | | | | | | | |
| COMPARATIVE | WET TYPE | BURNING | 110 | 12 | 25 | 1500 | 3 |
| EXAMPLE 8 | | | | | | | |
| COMPARATIVE | WET TYPE | BURNING | 110 | 12 | 25 | 2000 | 5 |
| EXAMPLE 9 | | | | | | | |
| COMPARATIVE | WET TYPE | BURNING | 110 | 12 | 25 | 2000 | 5 |
| EXAMPLE 10 | | | | | | | |
| COMPARATIVE | WET TYPE | BURNING | 110 | 12 | 25 | 2000 | 5 |
| EXAMPLE 11 | | | | | | | |
| COMPARATIVE | WET TYPE | BURNING | 110 | 12 | 25 | 2000 | 5 |
| EXAMPLE 12 | | | | | | | |
| COMPARATIVE | WET TYPE | BURNING | 110 | 12 | 25 | 1500 | 5 |
| EXAMPLE 13 | | | | | | | |
| COMPARATIVE | WET TYPE | BURNING | 110 | 12 | 25 | 1500 | 5 |
| EXAMPLE 14 | | | | | | | |
| COMPARATIVE | WET TYPE | BURNING | 110 | 12 | 45 | 2500 | 10 |
| EXAMPLE 15 | | | | | | | |
| COMPARATIVE | WET TYPE | BURNING | 110 | 12 | 45 | 2500 | 10 |
| EXAMPLE 16 | | | | | | | |
| COMPARATIVE | WET TYPE | BURNING | 110 | 12 | 25 | 1500 | 5 |
| EXAMPLE 17 | | | | | | | |
| COMPARATIVE | WET TYPE | BURNING | 110 | 12 | 25 | 1500 | 5 |
| EXAMPLE 18 | | | | | | | |
| COMPARATIVE | WET TYPE | BURNING | 110 | 12 | 45 | 2500 | 10 |
| EXAMPLE 19 | | | | | | | |
| COMPARATIVE | WET TYPE | BURNING | 110 | 12 | 45 | 2500 | 10 |
| EXAMPLE 20 | | | | | | | |

TABLE 2

| | | | | a/b × 100(%) | | |
|---|---|---|---|---|---|---|
| | | | | LOWER LIMIT | UPPER LIMIT | |
| | RESIDUAL | | | VALUE OF | VALUE OF | ACTUALLY |
| | RATIO X | α + β | | CALCULATED | CALCULATED | MEASURED |
| | (%) | (WEIGHT %) | β/α | VALUE | VALUE | VALUE |
| COMPARATIVE | 70 | 6 | 3.5 | 18.4 | 25.3 | 21 |
| EXAMPLE 1 | | | | | | |
| COMPARATIVE | 70 | 6 | 3.5 | 18.4 | 25.3 | 21 |
| EXAMPLE 2 | | | | | | |
| COMPARATIVE | 70 | 6 | 3.5 | 18.4 | 25.3 | 21 |
| EXAMPLE 3 | | | | | | |
| COMPARATIVE | 70 | 6 | 3.5 | 18.4 | 25.3 | 21 |
| EXAMPLE 4 | | | | | | |
| COMPARATIVE | 70 | 6 | 3.5 | 18.4 | 25.3 | 21 |
| EXAMPLE 5 | | | | | | |
| COMPARATIVE | 70 | 6 | 3.5 | 18.4 | 25.3 | 21 |
| EXAMPLE 6 | | | | | | |
| COMPARATIVE | 70 | 6 | 3.5 | 18.4 | 25.3 | 21 |
| EXAMPLE 7 | | | | | | |
| COMPARATIVE | 49 | 6 | 3.5 | 12.2 | 19.7 | 18 |
| EXAMPLE 8 | | | | | | |
| COMPARATIVE | 70 | 1 | 3.5 | 18.4 | 25.3 | 21 |
| EXAMPLE 9 | | | | | | |
| COMPARATIVE | 70 | 11 | 3.5 | 18.4 | 25.3 | 21 |
| EXAMPLE 10 | | | | | | |
| COMPARATIVE | 70 | 6 | 1.9 | 31.8 | 45.7 | 38 |
| EXAMPLE 11 | | | | | | |
| COMPARATIVE | 70 | 6 | 5.1 | 13.0 | 17.5 | 15 |
| EXAMPLE 12 | | | | | | |
| COMPARATIVE | 50 | 6 | 2 | 20.0 | 33.3 | 19 |
| EXAMPLE 13 | | | | | | |
| COMPARATIVE | 50 | 6 | 2 | 20.0 | 33.3 | 35 |
| EXAMPLE 14 | | | | | | |
| COMPARATIVE | 95 | 6 | 2 | 46.3 | 49.8 | 45 |
| EXAMPLE 15 | | | | | | |
| COMPARATIVE | 95 | 6 | 2 | 46.3 | 49.8 | 51 |
| EXAMPLE 16 | | | | | | |
| COMPARATIVE | 50 | 6 | 5 | 9.1 | 14.3 | 8 |
| EXAMPLE 17 | | | | | | |
| COMPARATIVE | 50 | 6 | 5 | 9.1 | 14.3 | 16 |
| EXAMPLE 18 | | | | | | |
| COMPARATIVE | 95 | 6 | 5 | 18.8 | 19.9 | 17 |
| EXAMPLE 19 | | | | | | |
| COMPARATIVE | 95 | 6 | 5 | 18.8 | 19.9 | 21 |
| EXAMPLE 20 | | | | | | |

TABLE 3

| | IMAGE | FOGGING | INITIAL | | RESIDUAL | | |
|---|---|---|---|---|---|---|---|
| | DENSITY | AFTER | IMAGE | INITIAL | AMOUNT OF | TONER | |
| | AFTER USE | USE | DENSITY | FOGGING | CARTRIDGE | BLOCKING | FIXABILITY |
| COMPARATIVE | X | ◯ | ◯ | ◯ | ◯ | ◯ | ◯ |
| EXAMPLE 1 | | | | | | | |
| COMPARATIVE | ◯ | X | ◯ | ◯ | X | ◯ | ◯ |
| EXAMPLE 2 | | | | | | | |
| COMPARATIVE | ◯ | X | ◯ | ◯ | X | ◯ | ◯ |
| EXAMPLE 3 | | | | | | | |
| COMPARATIVE | Δ | ◯ | ◯ | ◯ | ◯ | ◯ | ◯ |
| EXAMPLE 4 | | | | | | | |
| COMPARATIVE | ◯ | Δ | ◯ | ◯ | ◯ | ◯ | ◯ |
| EXAMPLE 5 | | | | | | | |
| COMPARATIVE | Δ | ◯ | ◯ | ◯ | ◯ | ◯ | ◯ |
| EXAMPLE 6 | | | | | | | |
| COMPARATIVE | ◯ | Δ | ◯ | ◯ | X | ◯ | ◯ |
| EXAMPLE 7 | | | | | | | |
| COMPARATIVE | ◯ | X | ◯ | ◯ | ◯ | ◯ | ◯ |
| EXAMPLE 8 | | | | | | | |
| COMPARATIVE | ◯ | ◯ | ◯ | ◯ | X | X | ◯ |
| EXAMPLE 9 | | | | | | | |
| COMPARATIVE | ◯ | ◯ | ◯ | ◯ | ◯ | ◯ | X |
| EXAMPLE 10 | | | | | | | |
| COMPARATIVE | ◯ | ◯ | ◯ | X | ◯ | ◯ | ◯ |
| EXAMPLE 11 | | | | | | | |
| COMPARATIVE | ◯ | ◯ | X | ◯ | ◯ | ◯ | ◯ |
| EXAMPLE 12 | | | | | | | |
| COMPARATIVE | X | ◯ | ◯ | ◯ | ◯ | ◯ | ◯ |
| EXAMPLE 13 | | | | | | | |
| COMPARATIVE | ◯ | X | ◯ | ◯ | ◯ | ◯ | ◯ |
| EXAMPLE 14 | | | | | | | |
| COMPARATIVE | X | ◯ | ◯ | ◯ | ◯ | ◯ | ◯ |
| EXAMPLE 15 | | | | | | | |
| COMPARATIVE | ◯ | X | ◯ | ◯ | ◯ | ◯ | ◯ |
| EXAMPLE 16 | | | | | | | |
| COMPARATIVE | X | ◯ | ◯ | ◯ | ◯ | ◯ | ◯ |
| EXAMPLE 17 | | | | | | | |
| COMPARATIVE | ◯ | X | ◯ | ◯ | ◯ | ◯ | ◯ |
| EXAMPLE 18 | | | | | | | |
| COMPARATIVE | X | ◯ | ◯ | ◯ | ◯ | ◯ | ◯ |
| EXAMPLE 19 | | | | | | | |
| COMPARATIVE | ◯ | X | ◯ | ◯ | ◯ | ◯ | ◯ |
| EXAMPLE 20 | | | | | | | |

TABLE 4

| | | | | | | ROTATION | |
|---|---|---|---|---|---|---|---|
| | | | φA | φB | TEMPERATURE | NUMBER | AGITATION |
| | A | B | (nm) | (nm) | (° C.) | (ROTATIONS/MIN) | TIME(MIN) |
| EXAMPLE 1 | WET TYPE | BURNING | 110 | 12 | 25 | 1500 | 5 |
| EXAMPLE 2 | WET TYPE | BURNING | 110 | 12 | 25 | 1500 | 5 |
| EXAMPLE 3 | WET TYPE | BURNING | 110 | 12 | 45 | 2500 | 10 |
| EXAMPLE 4 | WET TYPE | BURNING | 110 | 12 | 45 | 2500 | 10 |
| EXAMPLE 5 | WET TYPE | BURNING | 110 | 12 | 25 | 1500 | 5 |
| EXAMPLE 6 | WET TYPE | BURNING | 110 | 12 | 25 | 1500 | 5 |
| EXAMPLE 7 | WET TYPE | BURNING | 110 | 12 | 45 | 2500 | 10 |
| EXAMPLE 8 | WET TYPE | BURNING | 110 | 12 | 45 | 2500 | 10 |
| EXAMPLE 9 | WET TYPE | BURNING | 110 | 12 | 25 | 1500 | 5 |
| EXAMPLE 10 | WET TYPE | BURNING | 110 | 12 | 25 | 1500 | 5 |
| EXAMPLE 11 | WET TYPE | BURNING | 110 | 12 | 45 | 2500 | 10 |
| EXAMPLE 12 | WET TYPE | BURNING | 110 | 12 | 45 | 2500 | 10 |
| EXAMPLE 13 | WET TYPE | BURNING | 110 | 12 | 25 | 2000 | 5 |
| EXAMPLE 14 | WET TYPE | BURNING | 110 | 12 | 25 | 2000 | 5 |
| EXAMPLE 15 | WET TYPE | BURNING | 110 | 12 | 25 | 2000 | 5 |
| EXAMPLE 16 | WET TYPE | BURNING | 110 | 12 | 25 | 2000 | 5 |
| EXAMPLE 17 | WET TYPE | BURNING | 80 | 8 | 25 | 1500 | 5 |
| EXAMPLE 18 | WET TYPE | BURNING | 80 | 8 | 45 | 2500 | 10 |
| EXAMPLE 19 | WET TYPE | BURNING | 150 | 20 | 25 | 1500 | 5 |
| EXAMPLE 20 | WET TYPE | BURNING | 150 | 20 | 45 | 2500 | 10 |
| EXAMPLE 21 | WET TYPE | BURNING | 110 | 12 | 25 | 1500 | 5 |
| EXAMPLE 22 | WET TYPE | BURNING | 110 | 12 | 45 | 2500 | 10 |

TABLE 5

| | | | | a/b × 100(%) | | |
|---|---|---|---|---|---|---|
| | | | | LOWER LIMIT | UPPER LIMIT VALUE | ACTUALLY |
| | RESIDUAL | α + β | | VALUED OF | OF CALCULATED | MEASURED |
| | RATIO X(%) | (WEIGHT %) | β/α | CALCULATED VALUE | VALUE | VALUED |
| EXAMPLE 1 | 50 | 6 | 2 | 20.0 | 33.3 | 20 |
| EXAMPLE 2 | 50 | 6 | 2 | 20.0 | 33.3 | 33 |
| EXAMPLE 3 | 95 | 6 | 2 | 46.3 | 49.8 | 47 |
| EXAMPLE 4 | 95 | 6 | 2 | 46.3 | 49.8 | 49 |
| EXAMPLE 5 | 50 | 6 | 5 | 9.1 | 14.3 | 10 |
| EXAMPLE 6 | 50 | 6 | 5 | 9.1 | 14.3 | 14 |
| EXAMPLE 7 | 95 | 6 | 5 | 18.8 | 19.9 | 19 |
| EXAMPLE 8 | 95 | 6 | 5 | 18.8 | 19.9 | 19 |
| EXAMPLE 9 | 50 | 6 | 3.5 | 12.5 | 20.0 | 13 |
| EXAMPLE 10 | 50 | 6 | 3.5 | 12.5 | 20.0 | 20 |
| EXAMPLE 11 | 95 | 6 | 3.5 | 26.8 | 28.5 | 27 |
| EXAMPLE 12 | 95 | 6 | 3.5 | 26.8 | 28.5 | 28 |
| EXAMPLE 13 | 70 | 6 | 2 | 30.4 | 43.5 | 31 |
| EXAMPLE 14 | 70 | 6 | 2 | 30.4 | 43.5 | 43 |
| EXAMPLE 15 | 70 | 6 | 5 | 13.2 | 17.9 | 14 |
| EXAMPLE 16 | 70 | 6 | 5 | 13.2 | 17.9 | 17 |
| EXAMPLE 17 | 50 | 6 | 5 | 9.1 | 14.3 | 10 |
| EXAMPLE 18 | 95 | 6 | 5 | 18.8 | 19.9 | 19 |
| EXAMPLE 19 | 50 | 6 | 2 | 20.0 | 33.3 | 33 |
| EXAMPLE 20 | 95 | 6 | 2 | 46.3 | 49.8 | 49 |
| EXAMPLE 21 | 50 | 2 | 3.5 | 12.5 | 20.0 | 13 |
| EXAMPLE 22 | 95 | 10 | 3.5 | 26.8 | 28.5 | 28 |

TABLE 6

| | IMAGE | FOGGING | INITIAL | | RESIDUAL | | |
|---|---|---|---|---|---|---|---|
| | DENSITY | AFTER | IMAGE | INITIAL | AMOUNT OF | TONER | |
| | AFTER USE | USE | DENSITY | FOGGING | CARTRIDGE | BLOCKING | FIXABILITY |
| EXAMPLE 1 | ∘ | ∘ | ∘ | ∘ | ∘ | ∘ | ∘ |
| EXAMPLE 2 | ∘ | ∘ | ∘ | ∘ | ∘ | ∘ | ∘ |
| EXAMPLE 3 | ∘ | ∘ | ∘ | ∘ | ∘ | ∘ | ∘ |
| EXAMPLE 4 | ∘ | ∘ | ∘ | ∘ | ∘ | ∘ | ∘ |
| EXAMPLE 5 | ∘ | ∘ | ∘ | ∘ | ∘ | ∘ | ∘ |
| EXAMPLE 6 | ∘ | ∘ | ∘ | ∘ | ∘ | ∘ | ∘ |
| EXAMPLE 7 | ∘ | ∘ | ∘ | ∘ | ∘ | ∘ | ∘ |
| EXAMPLE 8 | ∘ | ∘ | ∘ | ∘ | ∘ | ∘ | ∘ |
| EXAMPLE 9 | ∘ | ∘ | ∘ | ∘ | ∘ | ∘ | ∘ |
| EXAMPLE 10 | ∘ | ∘ | ∘ | ∘ | ∘ | ∘ | ∘ |
| EXAMPLE 11 | ∘ | ∘ | ∘ | ∘ | ∘ | ∘ | ∘ |
| EXAMPLE 12 | ∘ | ∘ | ∘ | ∘ | ∘ | ∘ | ∘ |
| EXAMPLE 13 | ∘ | ∘ | ∘ | ∘ | ∘ | ∘ | ∘ |
| EXAMPLE 14 | ∘ | ∘ | ∘ | ∘ | ∘ | ∘ | ∘ |
| EXAMPLE 15 | ∘ | ∘ | ∘ | ∘ | ∘ | ∘ | ∘ |
| EXAMPLE 16 | ∘ | ∘ | ∘ | ∘ | ∘ | ∘ | ∘ |
| EXAMPLE 17 | ∘ | ∘ | ∘ | ∘ | ∘ | ∘ | ∘ |
| EXAMPLE 18 | ∘ | ∘ | ∘ | ∘ | ∘ | ∘ | ∘ |
| EXAMPLE 19 | ∘ | ∘ | ∘ | ∘ | ∘ | ∘ | ∘ |
| EXAMPLE 20 | ∘ | ∘ | ∘ | ∘ | ∘ | ∘ | ∘ |
| EXAMPLE 21 | ∘ | ∘ | ∘ | ∘ | ∘ | ∘ | ∘ |
| EXAMPLE 22 | ∘ | ∘ | ∘ | ∘ | ∘ | ∘ | ∘ |

FIG. 2 is a diagram illustrating the relationship between the total addition amount of the wet silica and burning silica added in a developer and the percentage of the ratio of the residual amount (a) of the wet silica to the residual amount (b) of the burning silica.

Formulas (1) and (2) are calculated in the case where the total residual ratio X is 50% and β/α is 3 and then respectively shown as graphs 101 and 102 in FIG. 2.

In order to adjust the range of a/b properly, the total residual ratio X of the silica A and the silica B is changed from 40% to 95% by changing the conditions involved in the external addition process, under the situation that the ratio (β/α) of the amounts of the silica A and the silica B added for toner before use is 3, the percentage of the ratio (a/b) of the number (a) of the residual silica A to the number (b) of the residual silica B is variously changed to prepare a developer in the way used in embodiment 1, and developer proprieties, including image density, fogging, the residual amount in the cartridge, toner blocking and fixability, are investigated using the obtained developer.

As a result, in one of the obtained developers with excellent properties, the total addition amount of the wet silica and the burning silica added into the developer and the percentage of the ratio a/b fall within the range surrounded by charts 101 and 102 and two straight lines representing a total residual amount X of 40% and a total residual amount X of 95%, designed by oblique lines.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nonmagnetic single-component developer, comprising:
toner particles containing a binder resin and a coloring material; and
an external additive which is adhered on the surfaces of the toner particles and contains wet silica having a volume average primary particle size of 80-150 nm and accounting for α percent by weight of the total weight of the developer and burning silica having a volume average primary particle size of 8-20 nm and accounting for β percent by weight of the total weight of the developer, wherein
the ratio of β to α (β/α) is 2-5,
the total addition amount of the added wet silica and burning silica (α+β) is 2-10 percent by weight,
the residual ratio X of the wet silica and the burning silica left after a separation test to the total addition amount (α+β) of the wet silica and the burning silica calculated before the separation test is 50-95 percent by weight when the separation test of the wet silica and the burning silica is carried out by a centrifugal separation apparatus, and
the lower limit value and the upper limit value of the percentage of the ratio (a/b) of the residual amount (a) of the wet silica to the residual amount (b) of the burning silica are represented by the following formulas (1) and (2):
a/b(lower limit value)percent=(X²/(1+β/α)/100)/(X−X²/(1+β/α)/100)×100 (1)
a/b(upper limit value)percent=(X²/(1+β/α)/100×((1−X/100)+1))/(X−X²/(1+β/α)/100×((1−X/100)+1))×100 (2).

2. A development machine cartridge having a developing member contacted with an image carrier to develop an image and including a magnetic single-component development machine in which the developer claimed in claim 1 is housed.

3. A process cartridge having an image carrier and a developing member arranged opposite to the image carrier and contacted with the image carrier to develop an image, and including a magnetic single-component development machine in which the developer claimed in claim 1 is housed.

4. An image forming apparatus having an image carrier and a developing member arranged opposite to the image carrier and contacted with the image carrier to develop an image, and including a magnetic single-component development machine in which the developer claimed in claim 1 is housed.
